(19) United States
(12) Patent Application Publication
(10) Pub. No.: US 2022/0139163 A1
(43) Pub. Date: May 5, 2022

(54) METHOD OF CONSTANTLY DISPLAYING THE PROGRESS OF A GAME GOAL TO INCREASE USER ENGAGEMENT

(71) Applicant: AdrenalineIP, Washington, DC (US)

(72) Inventor: John CRONIN, Jericho, VT (US)

(73) Assignee: AdrenalineIP, Washington, DC (US)

(21) Appl. No.: 17/338,921

(22) Filed: Jun. 4, 2021

Related U.S. Application Data
(60) Provisional application No. 63/108,997, filed on Nov. 3, 2020.

(51) Int. Cl. G07F 17/32; G06Q 50/34

(52) U.S. Cl. CPC G07F 17/3258; G06Q 50/34; G07F 17/3288; G07F 17/323

(57) ABSTRACT

A system for a progressive game that allows users of a wagering app to recoup losses in the form of an individual progressive jackpot that will increase user engagement. The progressive jackpot contributions are displayed on the wagering app to increase user engagement. Each player who has lost money or points will have some percentage to go into an individual jackpot. Once the player or user has passed a predetermined threshold, the jackpot will be won by the individual player allowing the user or player to recoup some of their losses.

### FIELD

The embodiments are generally related to play-by-play wagering on live sporting events.

### BACKGROUND

Currently, an issue with wagering platforms is keeping users engaged after they have lost a wager. that users are less engaged than they lose as there is no way to recoup their losses besides wagering more money which can lead to the users stopping playing on a wagering app.

Users become more selective with their wagers the more they lose.

Also, there is currently no way for users of a wagering app to recoup losses besides wagering more, which may lead to increased losses and possible discontinued use of the wagering app altogether.

### SUMMARY

A method and system for implementing and displaying progress of a game goal. In one embodiment, a method for constantly displaying the progress of a game goal in a progressive game, can include receiving data from a live sporting event upon which single play wagers can be placed on plays inside of the live sporting event; receiving at least one wager from at least one user on a device communicatively coupled with a wagering network configured to host play by play wagering on the live sporting event; identifying whether the at least one wager resulted in a loss for the at least one user; determining how much the loss contributes to a net loss associated with the at least one user; and increasing the net loss based on a predetermined amount associated with the loss by the at least one user.

In another embodiment, a system for constantly displaying the progress of a game goal in a progressive game can be provided. The system can include a live sporting event upon which single play wagers can be placed on plays inside of the live sporting event at least one user device; at least one user device with a display; a wagering network communicatively coupled with the at least one user device; a progressive offer module, wherein the progressive offer module stores the wager results from the at least one user device in a progressive database; and a betting accrue module which receives wager results from the progressive database, and increases a net loss associated with the at least one user by a predetermined amount associated with the wager result.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1: illustrates a system for displaying individual jackpots to increase user engagement, according to an embodiment.

FIG. 2: illustrates a progressive offer module, according to an embodiment.

FIG. 3: illustrates a progressive database, according to an embodiment.

FIG. 4: illustrates a betting accrue module, according to an embodiment.

FIG. 5: illustrates a progress display module, according to an embodiment.

FIG. 6: illustrates a game prize module, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of the terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “bet” or “wager”. A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick 'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, or perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are services that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access, and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allows customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, by creating and delivering actionable insights on performance to help customers to manage the sports gaming. Business Applications can be integrated into the embodiments in a variety of manners.

State based integration allows for a given sports gambling game to be modified by states in the United States or other countries, based upon the state the player is in, based upon mobile phone or other geolocation identification means. State based integration can be integrated into the embodiments in a variety of manners.

Game Configurator allows for configuration of customer operators to have the opportunity to apply various chosen or newly created business rules on the game as well as to parametrize risk management. Game Configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

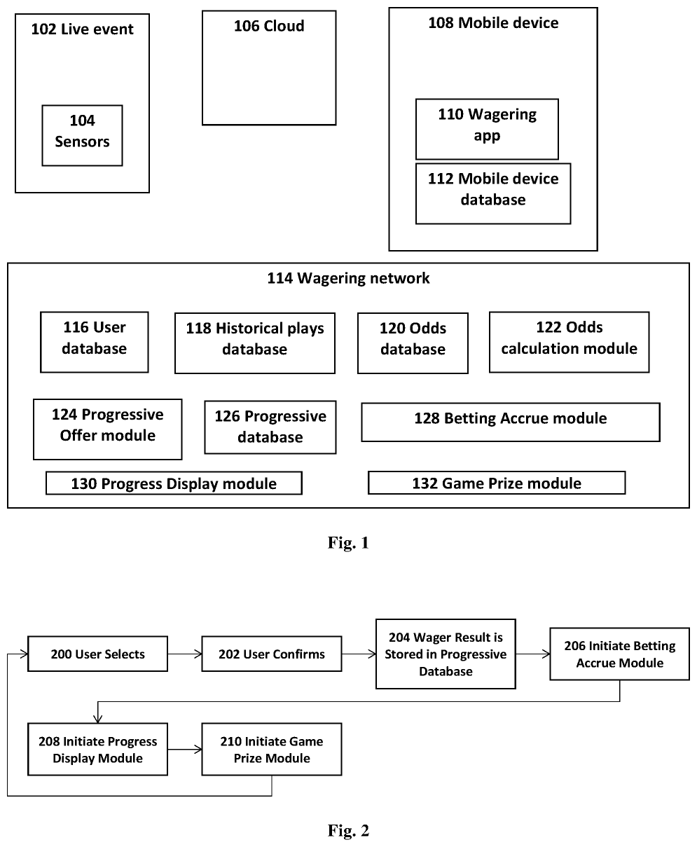

FIG. 1 is a system for displaying individual jackpots to increase user engagement. This system may include a live event 102, for example, a sporting event such as a football, basketball, baseball, or hockey game, tennis match, golf tournament, eSports or digital game, etc. The live event 102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 102, such as the score of an American football game or the run line in a baseball game, or a series of actions in the live event 102. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 102 or at another location.

Further, embodiments may include a plurality of sensors 104 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 104 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 106 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 106 may be communicatively coupled to a peer-to-peer wagering network 114, which may perform real-time analysis on the type of play and the result of the play. The cloud 106 may also be synchronized with game situational data such as the time of the game, the score, location on the field, weather conditions, and the like, which may affect the choice of play utilized. For example, in an exemplary embodiment, the cloud 106 may not receive data gathered from the sensors 104 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and would be utilized in a situation where a paired wearable device employs the mobile device 108 for additional memory or computing power or connection to the internet.

Further, embodiments may include a wagering software application or a wagering app 110, which is a program that enables the user to place bets on individual plays in the live event 102, streams audio and video from the live event 102, and features the available wagers from the live event 102 on the mobile device 108. The wagering app 110 allows the user to interact with the wagering network 114 to place bets and provide payment/receive funds based on wager outcomes.

Further, embodiments may include a mobile device database 112 that may store some or all the user's data, the live event 102, or the user's interaction with the wagering network 114.

Further, embodiments may include the wagering network 114, which may perform real-time analysis on the type of play and the result of a play or action. The wagering network 114 (or the cloud 106) may also be synchronized with game situational data, such as the time of the game, the score, location on the field, weather conditions, and the like, which may affect the choice of play utilized. For example, in an exemplary embodiment, the wagering network 114 may not receive data gathered from the sensors 104 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 114 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 116, which may contain data relevant to all users of the wagering network 114 and may include, but is not limited to, a user ID, a device identifier, a paired device identifier, wagering history, or wallet information for the user. The user database 116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 116 may contain betting lines and search queries. The user database 116 may be searched based on a search criterion received from the user. Each betting line may include, but is not limited to, a plurality of betting attributes such as at least one of the live event 102, a team, a player, an amount of wager, etc. The user database 116 may include, but is not limited to, information related to all the users involved in the live event 102. In one exemplary embodiment, the user database 116 may include information for generating a user authenticity report and a wagering verification report. Further, the user database 116 may be used to store user statistics like, but not limited to, the retention period for a particular user, frequency of wagers placed by a particular user, the average amount of wager placed by each user, etc.

Further, embodiments may include a historical plays database 118 that may contain play data for the type of sport being played in the live event 102. For example, in American Football, for optimal odds calculation, the historical play data may include metadata about the historical plays, such as time, location, weather, previous plays, opponent, physiological data, etc. Further, embodiments may utilize an odds database 120—that contains the odds calculated by an odds calculation module 122—to display the odds on the user's mobile device 108 and take bets from the user through the mobile device wagering app 110.

Further, embodiments may include the odds calculation module 122, which utilizes historical play data to calculate odds for in-play wagers.

Further, embodiments may include a progressive offer module 124, which begins with the user selecting and confirming a wager on the wagering app 110. Next, the progressive offer module 124 may store the results of the wager in the progressive database 126. The progressive offer module 124 may then initiate the betting accrue module 128. The betting accrue module 128 may determine if the user's wager was a loss and if it was then the betting accrue module 128 may determine the jackpot contributions. The betting accrue module 128 may store the jackpot contributions in the progressive database 126 and may also filter the progressive database 126 for the user. Next, the betting accrue module 128 may determine the user's net loss and current total jackpot contributions. If it is determined that the user's wager was not a loss, then the betting accrue module 128 may store the win in the progressive database 126 and may return to the progressive offer module 124. The progressive offer module 124 may then initiate the progress display module 130. The progress display module 130 may continuously poll for the net loss and total jackpot contributions from the betting accrue module 128. Next, the progress display module 130 may receive the net loss and total jackpot contributions from the betting accrue module 128. The progress display module 130 may then display the net loss and total jackpot contributions on the wagering app 110. The progress display module 130 may then return to the progressive offer module 124. The progressive offer module 124 may initiate the game prize module 132. The game prize module 132 may filter the progressive database 126 and extract the wins and losses of the user. The game prize module 132 may determine that the user reached the jackpot threshold and if so, may send the jackpot to the user. The game prize module 132 may return to the progressive offer module 124 after the jackpot is sent to the user or if the user failed to reach the jackpot threshold.

Further, embodiments may include a progressive database 126 that may contain the wagers placed by a user during the progressive offer module 124 and the results and the jackpot contributions determined during the process described in the betting accrue module 128. The progressive database 126 may contain user IDs, such as JS123456, dates, such as Apr. 29, 2021, events, such as the Tampa Rays vs. Seattle Mariners, wagers, such as the first pitch of the game will result in a strike, wager amounts, such as $5, results, such as a win, or jackpot contributions which may be determined by the betting accrue module 128 if the wager resulted in a loss.

Further, embodiments may include a betting accrue module 128, which may determine if the user's wager was a loss. If the user's wager was a loss, then the betting accrue module 128 may determine the jackpot contributions. For example, there may be a percentage of the wagered amount, such as 10% of the lost wager, sent to a jackpot that the user has an opportunity to win back. This may increase user engagement by allowing the user to potentially recoup a portion of their losses. In some embodiments, the user may accrue points instead of a portion of the lost wager. For example, the user may accumulate one point for every one dollar lost in a wager. The betting accrue module 128 may then store the jackpot contributions in the progressive database 126. The betting accrue module 128 may filter the progressive database 126 for the user and determine the user's net loss and current total jackpot contributions. The betting accrue module 128 may determine the net loss of a given user by filtering the progressive database 126 for user losses, total amounts wagered by the user, and total jackpot contributions. In some embodiments, the total jackpot contributions may be points accrued by the user. The betting accrue module 128 may send the user's net loss and current total jackpot contributions to the progress display module 130. If it is determined that the user's wager was not a loss, then the betting accrue module 128 may store the win in the progressive database 126 and return to the progressive offer module 124.

Further, embodiments may include a progress display module 130, which may continuously poll for the user's net loss and total jackpot contributions from the betting accrue module 128. For example, the progress display module 130 may poll for the user's net loss and jackpot contributions from the betting accrue module 128 and may receive a message like, “User ID JS123456 has a net loss of $25 and a total of $2.50 contributed to the jackpot.” In some embodiments, the progress display module 130 may poll for the user's net loss amounts and the total points accrued. The progress display module 130 may then receive the net loss and total jackpot contributions from the betting accrue module 128 as shown above. The progress display module 130 may then display the net loss and total jackpot contributions on the wagering app 110. For example, for the user ID JS123456, the progress display module 130 may display a net loss of $25 and jackpot contributions of $2.50 on the wagering app's 110 user interface, informing the user of their current losses and how much they can potentially win back if they win the jackpot. The progress display module 130 may then return to the progressive offer module 124.

Further, embodiments may include a game prize module 132, which may filter the progressive database 126 for the user. The game prize module 132 may extract the user's wins and losses. The game prize module 132 may then determine if the user has reached the jackpot threshold. For example, a threshold may require that the user win a consecutive number of wagers, such as ten wagers, to secure the jackpot contributions. In some embodiments, the user may need to win a consecutive number of wagers within a certain time, such as ten wagers within one hour. In some embodiments, the user may need to win a consecutive number of wagers during one event, such as ten wagers during the Tampa Rays vs. Seattle Mariners event. In some embodiments, if the system is using a point system, the user may need to reach a specific number of points within a given time during a certain event or gain a certain number of points consecutively within a certain time, such as the user needs to accrue 100 points consecutively for ten wagers within one hour. If it is determined that the user reached the jackpot threshold, then the game prize module 132 may send the jackpot to the user. For example, if the user ID JS123456 passed the threshold of winning ten wagers consecutively, then they may win the $2.50 jackpot. The game prize module 132 may return to the progressive offer module 124 after the jackpot is sent to the user or if the user did not reach the jackpot.

FIG. 2 illustrates the progressive offer module 124. The process begins with the user selecting, at step 200, a wager on the wagering app 110. For example, the user selects a wager on the wagering app 110, such as the first pitch in the Tampa Rays vs. Seattle Mariners event will be a strike for $5. The user may confirm, at step 202, the wager on the wagering app 110. For example, the user may confirm a $5 wager on the result of the first pitch being a strike in the Tampa Rays vs. Seattle Mariners event. The progressive offer module 124 may store, at step 204, the results of the wager in the progressive database 126. For example, the progressive offer module 124 may store user IDs, such as J5123456, dates, such as Apr. 29, 2021, events, such as Tampa Rays vs. Seattle Mariners, wagers, such as the first pitch, will be a strike, wager amounts, such as $5, and potential results, such as a win. The progressive offer module 124 may initiate, at step 206, the betting accrue module 128. For example, the betting accrue module 128 may determine if the user's wager was a loss and if so, the betting accrue module 128 may determine the jackpot contributions. There may be a percentage of the wagered amount sent to a jackpot that the user may have an opportunity to win, thereby potentially increasing user engagement and allowing the user to possibly recoup a portion of their losses, such as 10% of the lost amount wagered. In some embodiments, the user may accrue points instead of a portion of lost wagered amounts. For example, the user may accumulate one point for every one dollar lost in a wager. The betting accrue module 128 may store the jackpot contributions in the progressive database 126. The betting accrue module 128 may filter the progressive database 126 for the user's net loss and current total jackpot contributions. For example, the betting accrue module 128 may determine the net loss for a given user by filtering the progressive database 126 for user losses, total amounts wagered by the user, and total jackpot contributions. In some embodiments, the total jackpot contributions may be points accrued by the user. The betting accrue module 128 may send the user's net loss and current total jackpot contributions to the progress display module 130. If the user's wager was not a loss, then the betting accrue module 128 may store the win in the progressive database 126 and returns to the progressive offer module 124. The progressive offer module 124 may initiate, at step 208, the progress display module 130. The progress display module 130 may continuously poll for the user's net loss and total jackpot contributions from the betting accrue module 128. For example, the progress display module 130 may poll to receive the user's net loss and jackpot contributions from the betting accrue module 128, and receive a message like, “User ID JS123456 has a net loss of $25 and a total of $2.50 contributed to the jackpot.” In some embodiments, the progress display module 130 may be polling for the net loss amounts and the total points accrued by a user. The progress display module 130 may receive the net loss and total jackpot contributions from the betting accrue module 128 as shown above. The progress display module 130 may display the net loss and total jackpot contributions on the wagering app 110. For example, for the user ID JS123456, the progress display module 130 may display a net loss of $25 and jackpot contributions of $2.50 on the wagering app's 110 user interface, informing the user of their current losses and how much they can potentially win back by securing the jackpot. The progress display module 130 may then return to the progressive offer module 124. The progressive offer module 124 may initiate, at step 210, the game prize module 132. The game prize module 132 may filter the progressive database 126 for the user. The game prize module 132 may extract the user's wins and losses. The game prize module 132 may then determine if the user has reached the jackpot threshold. For example, a threshold may require that the user win a consecutive number of wagers, such as ten wagers, to secure the jackpot contributions. In some embodiments, the user may need to win a consecutive number of wagers within a certain time, such as ten wagers within one hour. In some embodiments, the user may need to win a consecutive number of wagers during one event, such as ten wagers during the Tampa Rays vs. Seattle Mariners event. In some embodiments, if the system is using a point system, the user may need to reach a specific number of points within a given time during a certain event or gain a certain number of points consecutively within a certain time, such as the user needs to accrue 100 points consecutively for ten wagers within one hour. If it is determined that the user reached the jackpot threshold, then the game prize module 132 may send the jackpot to the user. For example, if the user ID JS123456 passed the threshold of winning ten wagers consecutively, then they may win the $2.50 jackpot. The game prize module 132 may return to the progressive offer module 124 after the jackpot is sent to the user or if the user did not reach the jackpot.

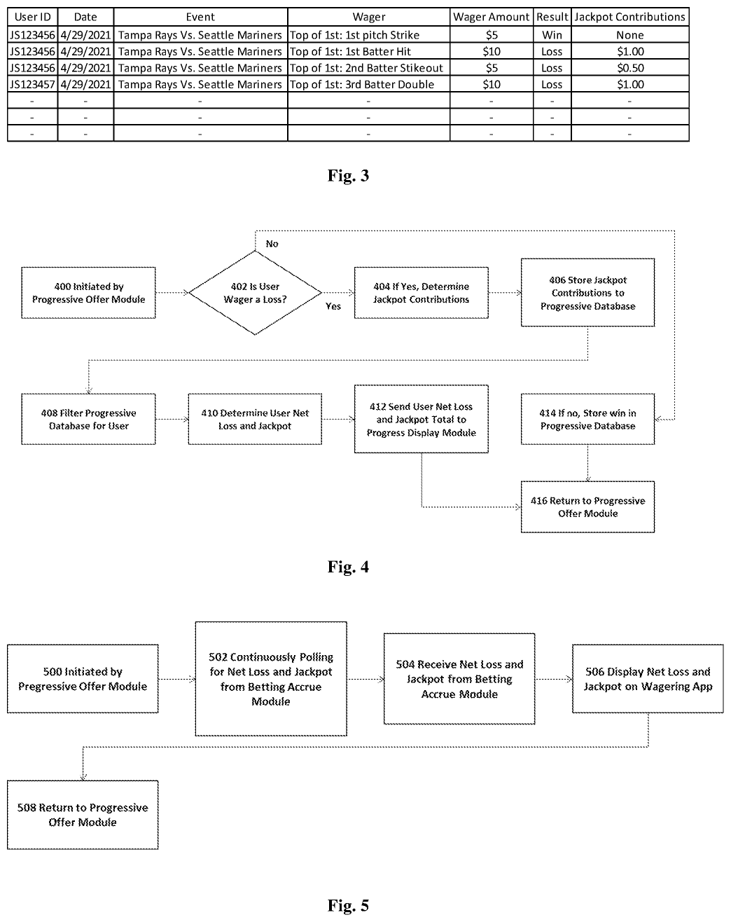

FIG. 3 Illustrates the progressive database 126. The progressive database 126 may contain the wagers placed by a user during the progressive offer module 124 and the results and the jackpot contributions determined during the process described in the betting accrue module 128. The progressive database 126 may contain user IDs, such as JS123456, dates, such as Apr. 29, 2021, events, such as the Tampa Rays vs. Seattle Mariners, wagers, such as the first pitch of the game will result in a strike, wager amounts, such as $5, results, such as a win, or the jackpot contributions which may be determined by the betting accrue module 128 if the wager resulted in a loss. In some embodiments, the jackpot contributions may be a percentage of the wagered amount, such as 10% of the lost amount wagered sent to a jackpot that the user may have an opportunity to win, thereby potentially increasing user engagement and allowing the user to possibly recoup a portion of their losses. In some embodiments, the user may accrue points instead of a portion of lost wagered amounts. For example, a user may accumulate one point for every one dollar lost in a wager. In some embodiments, the progressive database 126 may contain the threshold that the user needs to exceed to win the jackpot contributions. For example, a threshold may require the user win a consecutive number of wagers, such as ten wagers, to win the jackpot contributions. In some embodiments, the user may need to win a consecutive number of wagers within a specific time, such as ten wagers within one hour. In some embodiments, the user may need to win a certain number of wagers consecutively during one event, such as ten wagers during the Tampa Rays vs. Seattle Mariners event. In some embodiments, if the system is using a point system, the user may need to reach a certain number of points within a given time, during a certain event, or gain a certain number of points consecutively within a certain time, such as the user needs to accrue 100 points consecutively for ten wagers within one hour.

FIG. 4 Illustrates the betting accrue module 128. The process begins with the betting accrue module 128 being initiated, at step 400, by the progressive offer module 124. The betting accrue module 128 may determine, at step 402, if the user's wager was a loss. If the wager was not a loss the betting accrue module 128 may skip to step 414 otherwise it may proceed to step 404. The betting accrue module 128 may receive the result of a user's wager such as a win, a push—which is considered the same as not placing a bet and results in the amount wagered being returned to the user's account—or a loss. If the user's wager was a loss, then the betting accrue module 128 may determine, at step 404, the jackpot contributions. For example, there may be a percentage of the wagered amount, such as 10%, sent to a jackpot that the user may have an opportunity to win back thereby potentially increasing user engagement and allowing the user to possibly recoup a portion of their losses. In some embodiments, the user may accrue points instead of a portion of lost wagered amounts. For example, the user may accumulate one point for every one dollar lost in a wager. The betting accrue module 128 may store, at step 406, the jackpot contributions in the progressive database 126. A percentage of the wagered amount may be stored in the progressive database 126 to record the contribution to the jackpot. In some embodiments, the jackpot contributions may be a percentage of the user's lost wagered amount. In some embodiments, the jackpot contributions may be a point system in which points may be accumulated in the jackpot. The user may accrue points by losing wagers and may, for example, gain one point for every dollar lost. The betting accrue module 128 may filter, at step 408, the progressive database 126 for the user. For example, the betting accrue module 128 may filter the progressive database 126 for the user ID JS123456, to see their betting history. The betting accrue module 128 may determine, at step 410, the user's net loss and current total jackpot contributions. For example, the betting accrue module 128 may determine the net loss of a given user by filtering the progressive database 126 for user losses, total amounts wagered by the user, and total jackpot contributions. In some embodiments, the total jackpot contributions may be points accrued by the user. The betting accrue module 128 may send, at step 412, the user's net loss and current total jackpot contributions to the progress display module 130. For example, for the user ID JS123456, the total net loss may be $25, and total jackpot contributions may be $2.50. These totals may be sent to the progress display module 130 to be displayed to the user through the wagering app 110. If the user's wager was not a loss, then the betting accrue module 128 may store the win, at step 414, in the progressive database 126. For example, if a user won a wager, the result of “won” may be stored in the results column of the progressive database 126. The betting accrue module 128 may return to the progressive offer module 124 at step 416.

FIG. 5 Illustrates the progress display module 130. The process begins with the progress display module 130 being initiated, at step 500, by the progressive offer module 124. The progress display module 130 may continuously poll, at step 502, for the net loss and total jackpot contributions from the betting accrue module 128. For example, the progress display module 130 may poll to receive the user's net loss and jackpot contributions from the betting accrue module 128, and receive a message like, “User ID JS123456 has a net loss of $25 and a total of $2.50 contributed to the jackpot.” In some embodiments, the progress display module 130 may poll for the net loss amounts and the total points accrued by a user. The progress display module 130 may receive, at step 504, the net loss and total jackpot contributions from the betting accrue module 128 as shown above. The progress display module 130 may display, at step 506, the net loss and total jackpot contributions on the wagering app 110. For example, for the user ID JS123456, the progress display module 130 may display a net loss of $25 and jackpot contributions of $2.50 on the wagering app's 110 user interface, informing the user of their current losses and how much they can potentially win back by securing the jackpot. The progress display module 130 may return, at step 508, to the progressive offer module 124.

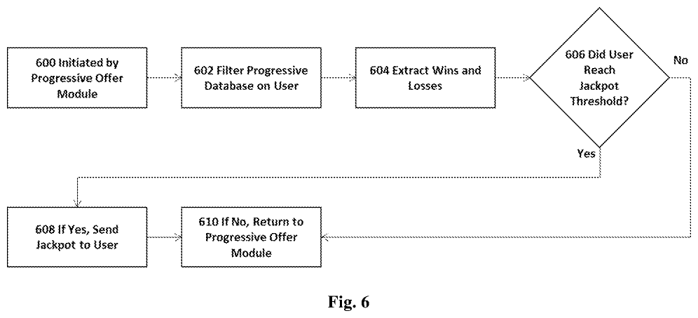

FIG. 6 Illustrates the game prize module 132. The process begins with the game prize module 132 being initiated, at step 600, by the progressive offer module 124. The game prize module 132 may filter, at step 602, the progressive database 126 for the user. For example, the game prize module 132 may filter the progressive database 126 for user ID JS123456. The game prize module 132 may extract, at step 604, the user's wins and losses stored in the progressive database 126. Then the game prize module 132 may determine, at step 606, if the user reached the jackpot eligibility threshold and may proceed to step 608 or may skip to step 610 if the threshold was not met. For example, a threshold may require the user needs to win a consecutive number of wagers, such as ten wagers, to win the jackpot contributions. In some embodiments, the user may need to win a consecutive number of wagers within a certain time, such as ten wins within one hour. In some embodiments, the user may need to win a consecutive number of wagers during one event, such as ten wagers during the Tampa Rays vs. Seattle Mariners event. In some embodiments, if the system is using a point system, the user may need to reach a certain number of points within a given time, during a specific event or gain a certain number of points consecutively within a certain time, such as the user needs to accrue 100 points consecutively for ten wagers within an hour. If the user reaches the jackpot eligibility threshold, then the game prize module 132 may send, at step 608, the jackpot to the user. For example, if the user ID JS123456 passed the threshold of winning ten wagers consecutively, then they would win the $2.50 in the jackpot. The game prize module 132 may return, at step 610, to the progressive offer module 124 after the user receives the jackpot or previously failed to meet the eligibility threshold as tested in step 606.

The foregoing description and accompanying figures illustrate the principles, preferred embodiments, and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method for constantly displaying the progress of a game goal in a progressive game implemented via a wagering network having at least a computer processor, comprising:
receiving data from a live sporting event upon which single play wagers can be placed on plays inside of the live sporting event, the data collected by at least one sensor provided at the live sporting event;
receiving at least one wager from at least one user on a mobile device communicatively coupled with the wagering network, the wagering network configured to host wagering on the live sporting event;
identifying whether the at least one wager resulted in a loss for the at least one user;
determining how much the loss contributes to a net loss associated with the at least one user;
increasing a potential jackpot award of the at least one user based on a predetermined amount associated with the net loss; and
awarding the at least one user with a progressive prize corresponding to the potential jackpot award when the at least one user reaches a predetermined threshold,
wherein the predetermined threshold requires that the at least one user wins a number of wagers within a time span.

2.-3. (canceled)

4. The method for constantly displaying the progress of the game goal in the progressive game of claim 1, wherein the predetermined threshold further requires that the number of wagers won by the at least one user be consecutively won.

5. (canceled)

6. The method for constantly displaying the progress of the game goal in the progressive game of claim 1, wherein the predetermined amount which the potential jackpot award is increased is a percentage of a value of the net loss.

7. The method for constantly displaying the progress of the game goal in the progressive game of claim 1, wherein the net loss is tracked by a point value system instead of a currency amount; and
a number of points contributed to the net loss is based on a value of the at least one wager that resulted in the loss for the at least one user.

8. The method for constantly displaying the progress of the game goal in the progressive game of claim 1, further comprising displaying the net loss to the at least one user on the mobile device.

9. The method for constantly displaying the progress of the game goal in the progressive game of claim 8, further comprising displaying how much each of the at least one wager contributed to the net loss.

10. A system for constantly displaying the progress of a game goal in a progressive game implemented via a wagering network having at least a computer processor, comprising:
a live sporting event upon which single play wagers can be placed on plays inside of the live sporting event at least one user device;
at least one sensor provided at the live sporting event for collecting data on the live sporting event:
at least one user device with a display; and
a communications network which communicatively couples the at least one user device with the wagering network,
wherein the computer processor is configured to:
store results of the wagers placed by a user of the at least one user device in a database,
identify which of the wagers placed by the user resulted in a loss for the user, a
determine how much the loss contributes to a net loss associated with the user,
increase a potential jackpot award of the at least one user based on a predetermined amount associated with the net loss, and
award the user with a progressive prize corresponding to the potential jackpot award when the user reaches a predetermined threshold;
wherein the predetermined threshold requires that the user wins a number of wagers within a time span.

11. The system for constantly displaying the progress of the game goal in the progressive game of claim 10, wherein the predetermined amount which the potential jackpot award is increased is a percentage of a value of the net loss.

12. The system for constantly displaying the progress of the game goal in the progressive game of claim 10, wherein the net loss is tracked by a point value system instead of a currency amount; and
a number of points contributed to the net loss is based on a value of those wagers that resulted in the loss for the user.

13. The system for constantly displaying the progress of the game goal in the progressive game of claim 10, wherein the computer processor is further configured to display wager results and the net loss on the at least one user device.

14. (canceled)

15. The system for constantly displaying the progress of a game goal in a progressive game of claim 10, wherein the predetermined threshold further requires that the number of wagers won by the user be consecutively won.

16. The system for constantly displaying the progress of the game goal in the progressive game of claim 4510, wherein the predetermined amount which the potential jackpot award is increased is a percentage of a value of the net loss.

17. The method for constantly displaying the progress of the game goal in the progressive game of claim 1, wherein the at least one sensor comprises a tracking device arranged on uniforms of players participating in the live sporting event, on or in game equipment used in the live sporting event, and/or on or in a field of play of the live event.

18. The method for constantly displaying the progress of the game goal in the progressive game of claim 1, wherein the at least one sensor is a camera configured to provide coordinate positioning of players and/or game balls.

19. The system for constantly displaying the progress of the game goal in the progressive game of claim 10, wherein the at least one sensor comprises a tracking device arranged on uniforms of players participating in the live sporting event, on or in game equipment used in the live sporting event, and/or on or in a field of play of the live event.

20. The system for constantly displaying the progress of the game goal in the progressive game of claim 10, wherein the at least one sensor is a camera configured to provide coordinate positioning of players and/or game balls.

21. The method for constantly displaying the progress of the game goal in the progressive game of claim 1, wherein the time span is a duration of the live sporting event.

22. The system for constantly displaying the progress of the game goal in the progressive game of claim 10, wherein the time span is a duration of the live sporting event.

23. The system method for constantly displaying the progress of the game goal in the progressive game of claim 1, wherein the wagering network hosts play by play wagering on the live sporting event.

24. The system method for constantly displaying the progress of the game goal in the progressive game of claim 1, wherein the at least one wager is a play by play wager.
